(19) United States
(12) Patent Application Publication
(10) Pub. No.: US 2008/0258032 A1
(43) Pub. Date: Oct. 23, 2008

(54) Actuator

(76) Inventor: Roger A. Bullivant, Burton on Trent (GB)

Correspondence Address: William R. Gustavson;Thompson & Gustavson, L.L.P., 210 S. Main, Suite 15, Duncanville, TX, 75116, US

(21) Appl. No.: 12/075,788

(22) Filed: Mar. 13, 2008

(30) Foreign Application Priority Data
Mar. 15, 2007 (GB) 0704955.4

(51) Int. Cl. F16M 13/00

(52) U.S. Cl. 248/562; 248/637

(57) ABSTRACT

An actuator (20) includes an attachment arrangement (30) for attachment to an item to be driven, such as a pile (12) and a vibrator arrangement using a vibrator (32) and plate (34). A suspension arrangement (38) is provided by which the attachment arrangement (30) can be supported on a carriage (36). The attachment arrangement (30) isolates the carriage (36) from vibration created by the vibrator (32) and the isolation characteristics are tunable.

The present invention relates to actuators particularly, but not exclusively, for applications in driving items into or out of the ground.

Piling operations for civil engineering purposes may require items such as piles to be driven into the ground or extracted, or formers to be driven into or out of the ground to form holes. Large vibration forces may be required in order to achieve this. For some purposes, these are accompanied by “crowd” forces, i.e. constant downward or upward bias forces onto which the vibration forces are superimposed. The presence of these forces, particularly the vibration forces, can create significant problems of wear and tear for the apparatus used.

In an aspect of the present invention, there is provided an actuator comprising:

an attachment arrangement for attaching the actuator to an item to be driven into or out of the ground;

a vibrator arrangement operable to apply vibration to the attachment arrangement;

a carriage member mountable on a support structure and to which crowd is applied, in use,

and a suspension arrangement by which the attachment arrangement is supported, in use, on the carriage member,

the suspension arrangement having frequency characteristics which, in use, convey crowd from the carriage member to the attachment arrangement, and in which, in use, isolate the carriage member from vibration created by the vibration arrangement, the isolation characteristics of the suspension arrangement being tunable.

The suspension arrangement may comprise at least one resilient member acting between the carriage member and the vibrator arrangement. The or at least one of the resilient members may be adjustable in resilience. The actuator may further comprise means operable to monitor the range of movement of the vibrator arrangement relative to the carriage member, in use, and to adjust the resilience in dependence on the result. The resilience may be adjusted to maintain the vibrator arrangement in a predetermined range of positions relative to the carriage member.

At least one of the resilient members may be pneumatic and may have an adjustable pneumatic pressure.

There may be at least two resilient members biasing the vibrator arrangement in substantially opposite directions relative to the carriage member. The resilient members may act in compression. A plurality of resilient members may be arranged to either side of the point of attachment of the vibrator arrangement to the attachment arrangement. The resilient members may be independently adjustable to compensate for the position of the centre of gravity of the vibrator arrangement.

The actuator may further comprise guide arrangements which, in use, constrain movement of the vibrator arrangement to a predetermined path relative to the carriage member, and or to constrain rotation of the vibration arrangement relative to the carriage member.

The actuator may comprise a torque arrangement operable to apply torque to the attachment arrangement.

The actuator may further comprise constraining means operable between the carriage member and the vibrator arrangement, to limit relative movement. The constraining means may limit movement transverse of the vibration direction, and/or in the direction of vibration.

Examples of the present invention will now be described in more detail, by way of example only, and with reference to the accompanying drawings, in which:

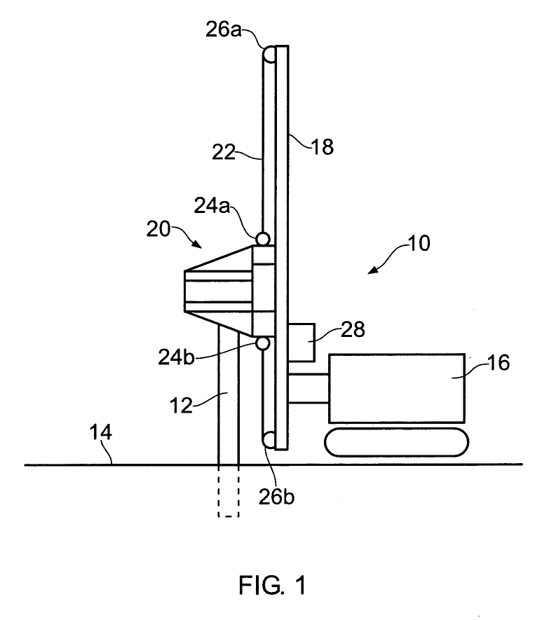

FIG. 1 is a highly simplified side elevation illustrating an actuator of the present invention in use;

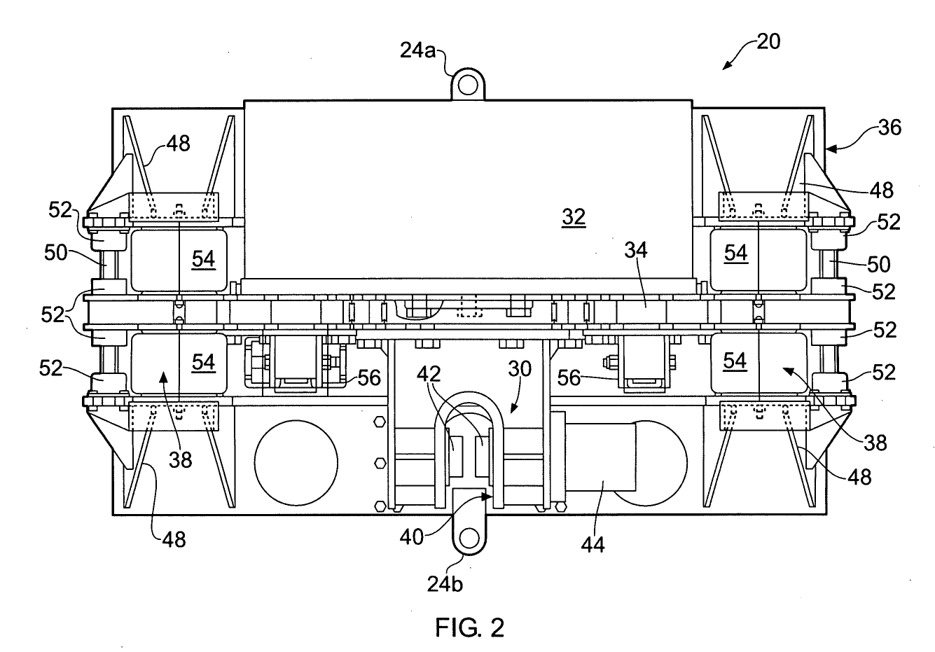

FIG. 2 is a front elevation of an actuator for use with the arrangement of FIG. 1;

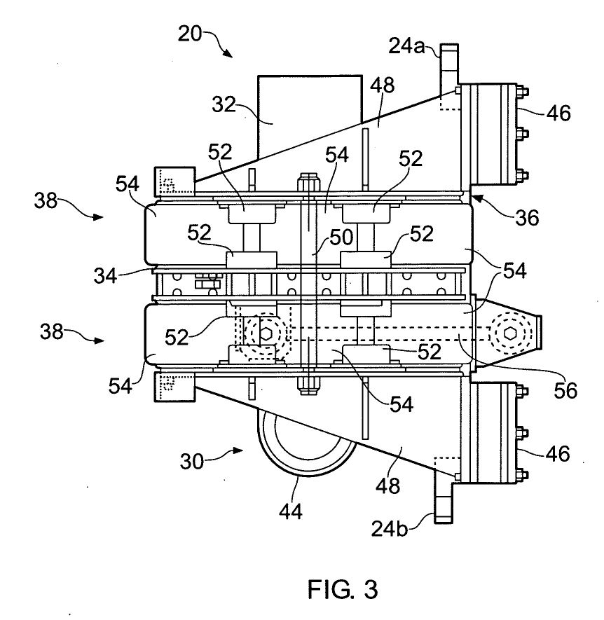

FIG. 3 is a side elevation of the actuator of FIG. 2;

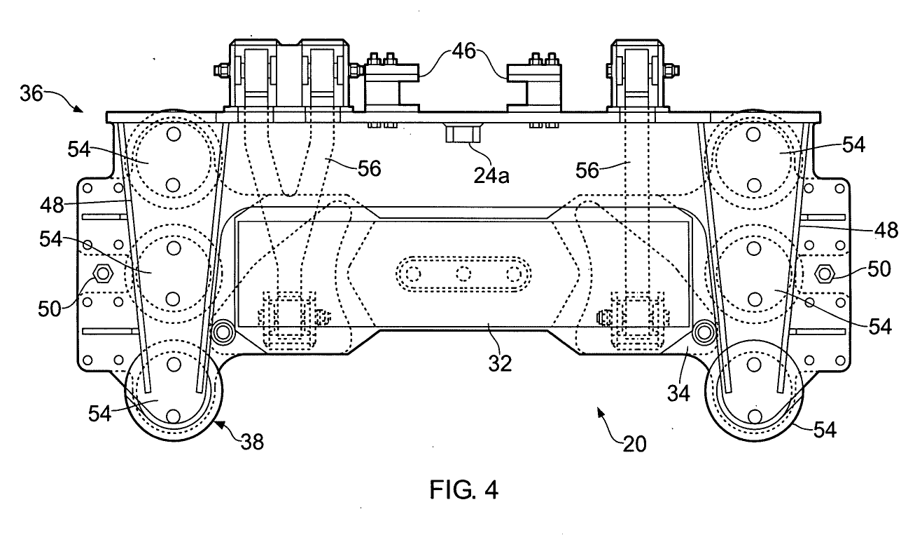

FIG. 4 is a plan view of the actuator of FIG. 2;

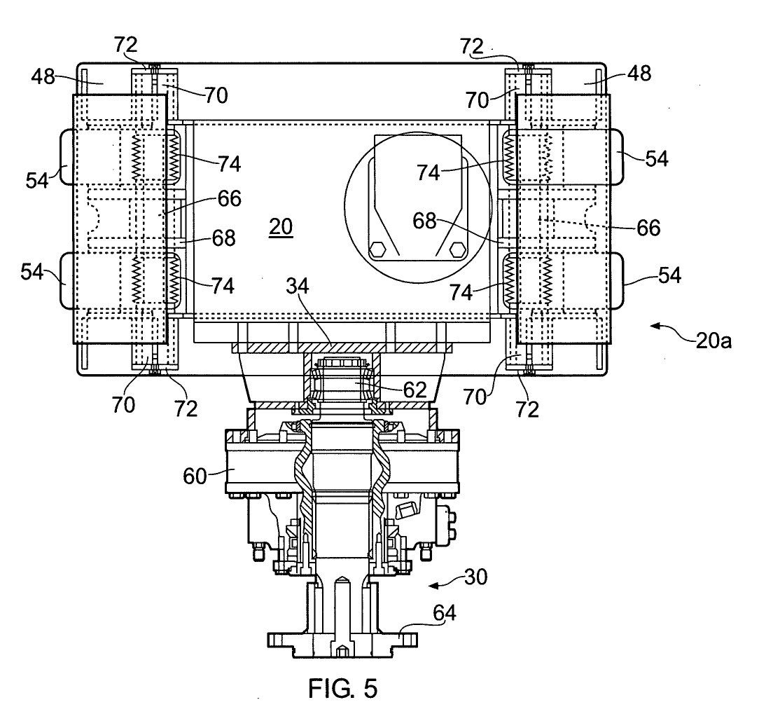

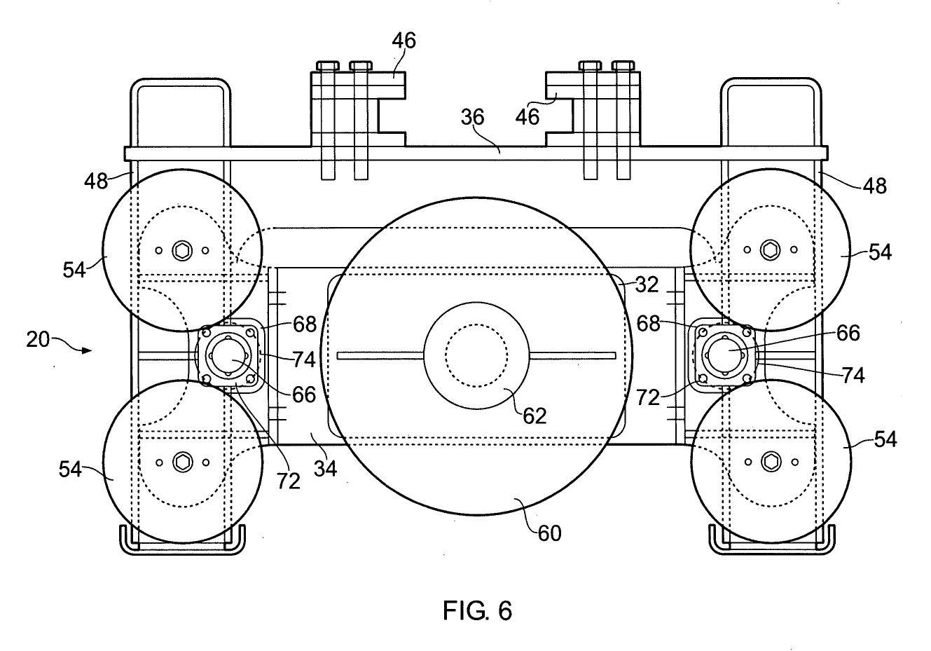

FIGS. 5 and 6 are respectively a front elevation and plan view of an alternative actuator for use with the arrangement of FIG. 1; and

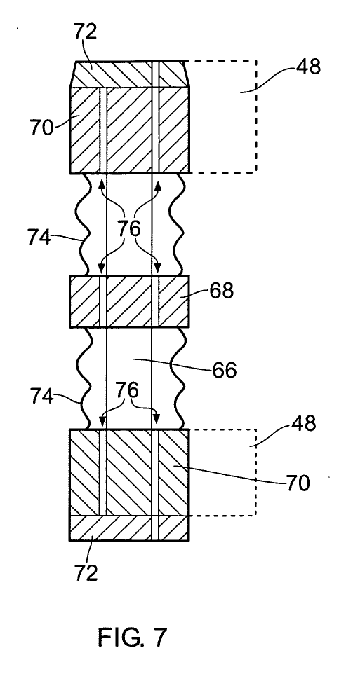

FIG. 7 is a simplified vertical section of a guide arrangement of the actuator of FIGS. 5 and 6.

FIG. 1 illustrates a rig 10 being used for vibratory driving of a pile 12 into the ground 14. The rig 10 includes a tracked motor unit 16 which carries a generally vertical track 18. The actuator 20 is coupled with the track 18 to rise or fall on the track 18. Movement of the actuator 20 on the track 18 can be achieved by pulling in the appropriate direction on a chain or cable 22 which is attached to an eye 24a at the top of the actuator 20, extends to a pulley 26a at the top of the track 18, down to a pulley 26b at the bottom of the track 18, and up to a second eye 24b at the bottom of the actuator 20. The leg of the chain or cable 22 from the pulley 26a to the pulley 26b is not visible in FIG. 1. A mechanism for applying force in either direction to the chain or cable 22 is provided at 28 and illustrated schematically. Prior to use, the force mechanism 28 can be used to move the actuator 28 up or down the track 18 to the required height. During use, the force mechanism 28 can be used to apply crowd to the actuator 20. Crowd is a substantially constant force applied as a biasing force in the downward direction (when driving a pile or other item into the ground) or an upward direction (when extracting a pile or other item from the ground).

Within the actuator 20, vibration is created (as will be described) and applied to the top of the pile 12. Accordingly, vibration and crowd forces are both applied to the pile 12, resulting in the pile being driven.

The actuator 20 can now be described in more detail with particular reference to the remaining drawings.

Briefly, the actuator 20 has an attachment arrangement 30 in the form of a clamp for attaching the actuator 20 to an item to be driven, such as a pile 12. Alternatively, the article 12 may be a pile former or other article, but is herein referred to simply as a pile, for simplicity. A vibrator arrangement is provided by a vibrator 32 and a plate 34. A carriage 36 is mountable on a support structure such as the track 18 and crowd is applied to the carriage 36, in use. A suspension arrangement indicated generally at 38 is provided, by which the attachment arrangement 30 is supported, in use, on the carriage 36. The suspension arrangement 38, in use, conveys crowd from the carriage 36 to the attachment arrangement 30 and, in use, isolates the carriage 36 from vibration created by the vibrator 32. The isolation characteristics of the suspension arrangement are tunable, as will be described.

In more detail, the attachment arrangement 30 defines a slot 40 for receiving the upper end of a pile 12, and has one or more movable clamp members 42, controlled by actuators such as hydraulic or pneumatic cylinders 44, allowing the clamp members 42 to be moved to grip or release a pile 12. The attachment arrangement 30 is carried by the plate 34 which also carries the vibrator 32, which may be hydraulically or pneumatically driven. For example, the vibrator 32 may consist of a rotary hydraulic motor (not shown), driving an eccentric weight.

Accordingly, vibration from the vibrator 32 is conveyed through the plate 34 to the clamp 30, and thus to a pile 12 clamped by the clamp members 42.

The carriage 36 has four cars 46 located at the two upper and two lower corners of the actuator 20. Corresponding upper and lower cars 46 are aligned and both run in a common track within the track 18. This allows the actuator 20 to ride up or down the track 18. Each car 46 carries a forwardly extending arm 48 which projects above or below the plate 34. The arms are connected at two positions by rods 50, which extend generally vertically between corresponding upper and lower arms 48. Opposed pairs of rubber bump stops 52 are provided on the arms 48 and on the plate 34 to limit relative movement, as will be described.

The plate 34 is supported on the carriage 36 by the suspension arrangement 38, which includes pneumatic bags 54. In this example, three bags 54 are provided between each arm 48 and the plate 34, giving a total of twelve bags 54. Each bag 54 is made of flexible material, such as a rubber. The bags 54 are individually inflatable and deflatable to set their pressure. Thus, each bag 54 acts resiliently, at least in compression, between the carriage 36 and the plate 34 (and hence between the carriage 36 and vibrator 32). The resilience of the bags 54 is adjustable by changing the inflation pressure of the bag 54.

Accordingly, it can be understood that with the bags 54 acting primarily in compression, there are resilient members biasing the plate 34 upwardly and downwardly relative to the carriage 36. Specifically, to either side of the vibrator 32, there are three bags 54 biasing the plate 34 in a downward direction, and three bags 54 biasing the plate 34 in an upward direction.

Further guidance of the plate 34 may be provided by arms 56, pivotally secured to the plate 34 and to the carriage 36, so that vertical movement of the plate 34 is not restricted by the arms 56, but the arms resist any movement of the plate 34 in a direction transverse to the vibration direction, relative to the carriage 36.

When the actuator 20 is to be used, the actuator 20 is first moved up or down the track 18 to allow the clamp 30 to engage the pile 12, or other object to be driven. Pressure in the bags 54 is then checked and adjusted if necessary, for reasons which will be explained below. Crowd is then applied to the carriage 36 and the vibrator 32 is set in motion.

As a result of the pressure in the bags 54, crowd applied to the carriage 36 is conveyed as a bias force through the bags 54 to provide bias to the plate 34 and then to the pile 12, through the clamp 30. Vibration is also applied to the pile 12 through the clamp 30, from the vibrator 32, as has been described. This results in vibration of the plate 34. However, the suspension arrangement 38 provides isolation of the carriage 36, from the vibration of the plate 34, if the pressure in the bags 54 is set to provide appropriate frequency characteristics within the suspension arrangement 38 to provide vibration isolation. It is found that the natural frequency of the suspension arrangement 38 can be changed by changing the pneumatic pressure in the bags 54. Accordingly, it is envisaged that appropriate choice of pneumatic pressure will allow the suspension arrangement 38 to act in the manner of a low pass filter, i.e. passing the constant crowd force from the carriage 36 to the plate 34, but blocking the higher frequency vibration of the vibrator 32 from passing from the plate 34 to the carriage 36. This protects the rig 10 from the adverse effects of the vibration which is expected to reduce wear and tear, but allows crowd to be applied by the rig, in the manner described above.

Typically, the resistance provided by bags 54 will increase as they become increasingly compressed. The restoring force resulting from a particular deflection of the plate 34 will depend on the initial pressure in the bag 54. Accordingly, setting the initial pressures in the various bags 54 allows the frequency characteristics of the suspension arrangement 38 to be varied and also allows variation to be incorporated to accommodate any displacement of a centre of gravity of the vibration arrangements 32, 34 from the position of the clamp 30. The initial selection of pressure may depend on the expected crowd and pull-out forces. In a further example, the position of the plate 34 may be monitored so that the pressure in the bags can be continuously adjusted to maintain the range of movement of the plate 34 to be within a chosen range. Thus, any misalignment, change of conditions etc. can be compensated. The bump stops 52 limit the range of movement, but the operating conditions are envisaged to be set to avoid the limit being reached.

FIGS. 5 and 6 illustrate an alternative actuator 20a. Many of the features of the actuator 20a are the same as, or closely correspond with features of the actuator 20, which has been described. Accordingly, the same reference numerals are used to indicate the same or the corresponding features and reference should be made to the above description in relation to these features. The actuator 20a has additional features, as follows.

The attachment arrangement 30 includes a rotary drive head 60 mounted by a thrust bearing to the plate 34 and operable, for example by hydraulic power, to drive rotation of a mounting flange 64 by means of which the actuator 20a is attached to a pile (or pile former or other article, herein called a pile) 12, during use. Hydraulic power is expected to be convenient for driving the rotary drive head 60, but other forms of motive power could alternatively be used. The mounting flange 64 could be replaced by alternative forms of attachment arrangement, such as clamp arrangements as described above in relation to FIGS. 2 to 4.

In use, operation of the vibrator 32 creates vibration of the plate 34, as has been described, and this is conveyed to the pile through the attachment arrangement 30. Thus, vibration is applied to the pile. In addition, activation of the rotary drive head 60 can be used to provide rotation to the pile. Accordingly, a pile can be driven by a combined vibration and rotation, with crowd also being applied from the carriage 36, as described above. Each of these forms of drive can be independently applied, so that the drive may be vibratory and/or rotary and/or with crowd.

When the rotary drive head 60 is operating, the driven pile will resist rotation by virtue of its engagement with the ground into which it is being driven. This will result in a reaction torque within the actuator 20a. The actuator 20a has provision for bearing this reaction torque, as follows.

Toward either side of the actuator 20a, guide pins 66 extend generally vertically between corresponding upper and lower arms 48. Guide bushes 68 are provided on the assembly of the vibrator 32 and plate 34 and fit over the guide pins 66. The guide bushes 68 can slide up and down the guide pins 66, during use, so that vibration of the type described above is substantially unimpeded by the pins 66 and bushes 68. However, the pins 66 and bushes 68 brace the vibrator 32 and plate 34 against lateral movement and against rotation around the rotation axis of the drive head 60. By preventing twisting in this manner, the pins 66 and bushes 68 bear the reaction torque arising from the operation of the drive head 60.

Movement of the bushes 68 on the pins 66 is lubricated to reduce wear, heat generation and frictional losses by an arrangement illustrated in simplified form in FIG. 7. The pin 66 carries the movable bush 68 and is seated at each end in fixed bushes 70 secured to the arms 48. End plates 72 may be used to retain the pin 66 in the fixed bushes 70. Gaiters 74, for example of flexible rubber, extend from each fixed bush 70 to the guide bush 68, creating an internal space around the pin 66 and of variable volume, according to the position of the bush 68 on the pin 66.

The guide bush 68 has a passage which is complementary in shape to the cross-section of the pin 66, except that the passage is locally widened at one or more positions around the circumference, to provide passages which interconnect the interior spaces of the gaiters 74. The internal spaces of the gaiters 74 are filled, in use, with lubricating oil. As the bush 68 moves on the pin 66, lubricating oil can pass through the passages 76 in the bush 68, allowing lubricating oil to move between the gaiters, thereby maintaining lubrication of the system, and substantially preventing build-up of pressure in the lubricating oil, as the bush 68 moves.

Similar lubrication passages 76 may be formed along the fixed bushes 70 to provide further improved movement of lubrication oil, and arrangements may be provided in the end plates 72 for filling and draining the lubrication oil.

In one example, a vibrator 32 may have a vibration frequency of 2000 cycles per minute (about 33 Hz). This may create a vibration amplitude for the plate 34 of approximately 10 mm. Crowd applied through the carriage 36 may cause an initial deflection of the plate 34 of approximately 125 mm. In the above examples, with a crowd force of approximately 10 tones, bag pressure may be in the order of 3 bar (3×10⁵ Pa) and with a crowd of approximately 15 tones, pressure may be in the region of 4.5 bar (4.5×10⁵ Pa).

Many variations and modifications can be made to the apparatus described above, without departing from the scope of the present invention. In particular, many different sizes, relative sizes, shapes and forms of the components may be used.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An actuator comprising:
an attachment arrangement for attaching the actuator to an item to be driven into or out of the ground;
a vibrator arrangement operable to apply vibration to the attachment arrangement;
a carriage member mountable on a support structure and to which crowd is applied, in use,
and a suspension arrangement by which the attachment arrangement is supported, in use, on the carriage member,
the suspension arrangement having frequency characteristics which, in use, convey crowd from the carriage member to the attachment arrangement, and in which, in use, isolate the carriage member from vibration created by the vibration arrangement, the isolation characteristics of the suspension arrangement being tunable.

2. An actuator according to claim 1, wherein the suspension arrangement comprises at least one resilient member acting between the carriage member and the vibrator arrangement.

3. An actuator according to claim 2, wherein the or at least one of the resilient members is adjustable in resilience.

4. An actuator according to claim 3, further comprising means operable to monitor the range of movement of the vibrator arrangement relative to the carriage member, in use, and to adjust the resilience in dependence on the result.

5. An actuator according to claim 4, wherein the resilience is adjusted to maintain the vibrator arrangement in a predetermined range of positions relative to the carriage member.

6. An actuator according to claim 2, wherein at least one of the resilient members is pneumatic.

7. An actuator according to claim 6, wherein at least one of the resilient members has an adjustable pneumatic pressure.

8. An actuator according to claim 2, comprising at least two resilient members biasing the vibrator arrangement in substantially opposite directions relative to the carriage member.

9. An actuator according to claim 8, wherein the resilient members act in compression.

10. An actuator according to claim 2, wherein a plurality of resilient members are arranged to either side of the point of attachment of the vibrator arrangement to the attachment arrangement.

11. An actuator according to claim 10, wherein the resilient members are independently adjustable to compensate for the position of the centre of gravity of the vibrator arrangement.

12. An actuator according to claim 1, and further comprising guide arrangements which, in use, constrain movement of the vibrator arrangement to a predetermined path relative to the carriage member.

13. An actuator according to claim 1, and further comprising guide arrangements which, in use, constrain rotation of the vibration arrangement relative to the carriage member.

14. An actuator according to claim 1, comprising a torque arrangement operable to apply torque to the attachment arrangement.

15. An actuator according to claim 1, further comprising constraining means operable between the carriage member and the vibrator arrangement, to limit relative movement.

16. An actuator according to claim 15, wherein the constraining means limit movement transverse of the vibration direction.

17. An actuator according to claim 15, wherein the constraining means limit movement in the direction of vibration.

18. (canceled)

19. (canceled)
